(19) United States
(12) Patent Application Publication
(10) Pub. No.: US 2025/0200287 A1
(43) Pub. Date: Jun. 19, 2025

(54) INTERPRETABLE DEBIASING OF VECTORIZED LANGUAGE REPRESENTATIONS WITH ITERATIVE ORTHOGONALIZATION

(71) Applicant: Visa International Service Association, San Francisco, CA (US)

(72) Inventors: Prince Osei Aboagye, San Ramon, CA (US); Yan Zheng, Los Altos, CA (US); Michael Yeh, Palo Alto, CA (US); Junpeng Wang, Santa Clara, CA (US); Huiyuan Chen, San Jose, CA (US); Zhongfang Zhuang, Mountain View, CA (US); Liang Wang, San Jose, CA (US); Wei Zhang, Fremont, CA (US)

(73) Assignee: Visa International Service Association, San Francisco, CA (US)

(21) Appl. No.: 18/849,307

(22) PCT Filed: Jun. 22, 2023
(86) PCT No.: PCT/US2023/068872

§ 371 Date: Sep. 20, 2024

Related U.S. Application Data
(60) Provisional application No. 63/354,554, filed on Jun. 22, 2022.

(51) Int. Cl. G06F 40/30

(52) U.S. Cl. CPC G06F 40/30

(57) ABSTRACT

A computer-implemented method for debiasing vectorized language representations can include identifying two (or more) pairs of concepts for which debiasing is desired, computing a mean vector for each concept, determining a center point for a rotation operation to orthogonalize based on the mean vectors, and shifting the vectors to the center point before performing a rectification operation (which can be a graded rotation), after which the vectors can be shifted back from the center point. If desired, the process can be performed iteratively.

### CROSS-REFERENCE TO RELATED APPLICATION

This application claims priority to U.S. Provisional Application No. 63/354,554, filed Jun. 22, 2022, the disclosure of which is incorporated herein by reference.

### BACKGROUND

This disclosure relates generally to natural language processing systems and methods and in particular to debiasing of vectorized language representations.

“Natural language processing” refers generally to computer-implemented techniques for interacting with users using human languages with natural vocabulary and syntax, as opposed to artificial languages or sets of prescribed commands that have been traditionally used for interacting with computers. Typically, natural language processing is implemented by training a neural network or other machine-learning model using a training corpus of documents, which may include dictionaries, news reports, textbooks, works of fiction, and/or other documents. Language models attempt to reflect relationships among words, e.g., synonyms or associations. Language models often rely on vectorized representations in which words are represented as vectors in a high-dimensional space (e.g., thousands of dimensions). Vector components are learned via a training process, with the result that relationships (e.g., similarities in meaning) among words are encoded in the vector components. Such vectorized language representations, also sometimes referred to as “word embeddings,” have proven to be a useful tool in enabling computers to interpret natural-language input and/or generate natural-language output.

Unfortunately, the training process can result in word embeddings that reflect biases that were present in the training corpus. As used herein, “bias” refers to any unwanted association between terms. For instance, due to prevalent gender stereotypes reflected in a training corpus, “doctor” may be associated with “man” while “nurse” is associated with “woman.” It is therefore desirable to “debias” representations of various words, for instance by modifying the vectors learned during a training process to remove unwanted associations.

### SUMMARY

Certain embodiments of the present invention relate to systems and methods for debiasing of vectorized language representations. These systems and methods can be applied to a variety of vectorized language representations. In some embodiments, a debiasing method can include identifying two (or more) pairs of contrasting concepts for which debiasing is desired, computing a subspace direction for each concept, determining a center point for a rectification operation to orthogonalize the subspace directions, and centering a word vector on the center point before performing a rectification operation (which can be a graded rotation), after which the word vector can be re-centered (or shifted back from the center point). In some embodiments, the process can be performed iteratively.

Some embodiments relate to a computer-implemented method that includes: obtaining a vectorized language representation for a plurality of words, wherein the vectorized language representation includes a plurality of vectors in a vector space such that each word has an associated vector; identifying two pairs of concepts to be debiased; obtaining a representative word list for each concept in each pair of concepts; computing, for each concept, a respective concept mean from the vectors associated with the words in the representative word list for that concept; computing a center point of the respective concept means; computing a respective subspace direction for each pair of concept means; and for one or more of the plurality of vectors in the vector space, computing a debiased vector, wherein computing the debiased vector includes: recentering the vector on the center point; performing a rectification operation on the vector with respect to the respective subspace directions; and un-recentering the vector. The debiased vectors can be added to the vectorized language representation, replacing or augmenting the original vectors as desired.

Some embodiments relate to computer systems having a memory to store a vectorized language representation and a processor coupled to the memory. The processor can be configured to: identify two pairs of concepts to be debiased; obtain a representative word list for each concept in each pair of concepts; compute, for each concept, a respective concept mean from the vectors associated with the words in the representative word list for that concept; compute a center point of the respective concept means; compute a respective subspace direction for each pair of concept means; and for one or more of the plurality of vectors in the vector space: recenter the vector on the center point; perform a rectification operation on the vector with respect to the respective subspace directions; and un-recenter the vector.

Some embodiments relate to computer-readable storage media having stored therein program code instructions that, when executed by a processor in a computer system, cause the computer system to perform a method comprising: obtaining a vectorized language representation including a plurality of words, wherein the vectorized language representation includes a plurality of vectors in a vector space such that each word has an associated vector; identifying a plurality of pairs of target concepts to be debiased; generating a representative word list for each concept in each pair of target concepts; computing, for each concept, a respective concept mean from the vectors associated with the words in the representative word list for that concept; computing a center point of the respective concept means; computing a respective subspace direction for each pair of concept means; centering each vector in the vectorized language representation on the center point; performing a first rectification of each vector with respect to a first two of the subspace directions; projecting a third one of the subspace directions onto the span of the first two subspace directions; performing a second rectification of each vector with respect to the third subspace direction and the projection; and uncentering each vector. In some embodiments, the first two of the subspace directions can be the most nearly orthogonal pair of the subspace directions.

In these and other embodiments, the acts of computing the respective concept means; computing the center point; computing the respective subspace directions; recentering the vector; performing the rectification operation; and un-recentering the vector until a stopping criterion is met. The stopping criterion can include, for example, a convergence criterion based on a change in a performance metric and/or a fixed number of iterations.

In these and other embodiments, performing the rectification operation on the vector can include: determining a rotation angle to apply to the vector; and rotating the vector by the rotation angle. The rotation angle can be based at least in part on a relative similarity of the vector to the respective subspace directions for each pair of concept means, or based at least in part on an angle between the vector and one of the subspace directions.

In these and other embodiments, vectorized language representations can be obtained from various sources, including structured text and/or unstructured text.

In these and other embodiments, the representative word lists can be generated entirely or in part by a human. In some embodiments, the processor can be further configured such that obtaining a representative word list for each concept in each pair of concepts includes, for at least one of the concepts: receiving an initial word list generated by a human; determining a mean of word vectors corresponding to words in the initial word list; and selecting words for the representative word list based on vector similarity to the mean of word vectors.

The following detailed description, together with the accompanying drawings, will provide a better understanding of the nature and advantages of the claimed invention.

### BRIEF DESCRIPTION OF THE DRAWINGS

FIGS. 1A-1D illustrate the OSCaR approach to debiasing using a simplified two-dimensional representation of word vectors.

FIG. 2 shows a flow diagram of a process for iterative subspace rectification according to some embodiments.

FIG. 3 shows a flow diagram of a process for iterative subspace rectification according to some embodiments.

FIG. 4 shows a table summarizing WEAT scores for a number of different debiasing processes, including processes according to particular embodiments.

FIG. 5 shows a table summarizing WEAT and dot product scores at different iterations for a conventional debiasing process and a process according to a particular embodiment.

FIG. 6 shows a table summarizing WEAT scores for a number of different debiasing processes, including processes according to particular embodiments, applied to different concept pairs.

FIGS. 7 and 8 show a table summarizing results of a cross validation study for a number of different debiasing processes, including processes according to particular embodiments. Shown are WEAT scores obtained for different debiasing processes applied to different concept pair; in FIG. 7, a test/train split of word lists was used, and in FIG. 8, all words were used for both training and testing.

FIG. 9 shows a table summarizing SWEAT scores for various concept pairs and various debiasing processes, including processes according to particular embodiments.

FIG. 10 shows a table summarizing WEAT scores and dot product scores for an iterative debiasing process according to a particular embodiments performed on three concept pairs.

FIG. 11 shows a table summarizing SWEAT scores for each concept pair at each iteration of an iterative debiasing process according to a particular embodiments performed on three concept pairs.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

Certain embodiments of the present invention relate to systems and methods for debiasing of vectorized language representations. Vectorized language representations can include contextualized embeddings (such as the known embedding processes ELMO, BERT, or RoBERTA) built on natural language data, as well as non-contextualized embeddings built on structured data (such as the known embedding processes Word2Vec, GloVe, or FastText). Vectorized language representations, or embeddings, map each word to a vector in a high-dimensional space. In some representations, the (cosine) similarity between words (vectors) captures similarity in meanings based on similarity in the contexts in which particular words were used. Techniques described herein can be applied to a variety of vectorized language representations, including embeddings based on structured data.

As used herein, the term “bias” refers to an unwanted association between words that may be reflected in a word embedding or vectorized representation. Such bias may be reflected in cosine similarity between vectors that, in the absence of bias, would be uncorrelated (or orthogonal). One example is gender bias. In an unbiased language representation, words denoting occupations (such as “doctor,” “nurse,” “programmer,” or “teacher”) are not correlated with words that identify or imply a particular gender (such as “man,” “father,” “king” or “woman,” “mother,” “queen”). However, if a language model is trained using a corpus that includes such correlations, the resulting language model may reflect these correlations. “Debiasing,” as used herein, refers to (post-training) operations on a vectorized language representation that remove correlations that may be learned during training.

A variety of techniques have been developed to debias language models by modifying the vectors for certain words to eliminate unwanted correlations. The modification is typically performed between linear subspaces. Some debiasing techniques rely on projection into a subspace, e.g., using principal component analysis. Examples include: linear projection (LP) (described in S. Dev et al., “Attenuating bias in word vectors,” in AISTATS, Proceedings of Machine Learning Research, pp. 879-887, 16-18 Apr. 2019); hard debiasing (HD) (described in T. Bolukbasi et al., “Man is to computer programmer as woman is to homemaker?debiasing word embeddings,” Advances in Neural Information Processing Systems 29 (2016); and iterative null space projection (INLP) (described in S. Ravfogel et al., “Null it out: Guarding protected attributes by iterative nullspace projection,” 2020). One recently developed technique is known as Orthogonal Subspace Correction and Rectification (OSCaR) (described in S. Dev et al., “Oscar: Orthogonal Subspace correction and rectification of biases in word embeddings,” in Proceedings of the 2021 Conference on Empirical Methods in Natural Language Processing, pp. 5034-5050, 7-11 Nov. 2021). OSCaR involves identifying two subspaces (e.g., a male-female gender subspace and an occupation subspace) and performing a continuous deformation of the embedding in the span of the two subspaces that orthogonalizes the two subspaces (and the concepts they represent).

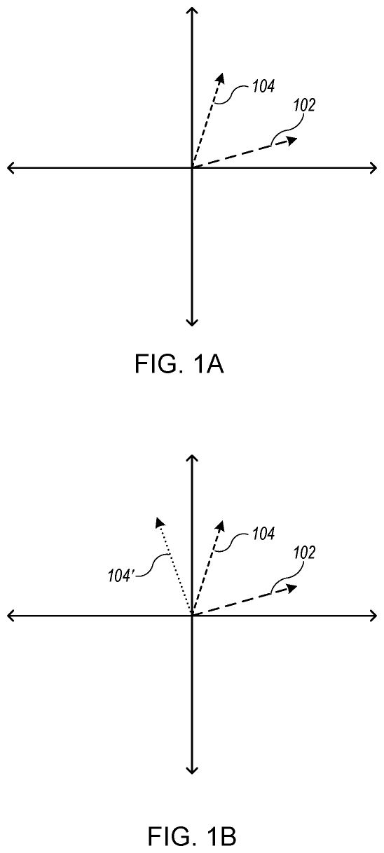

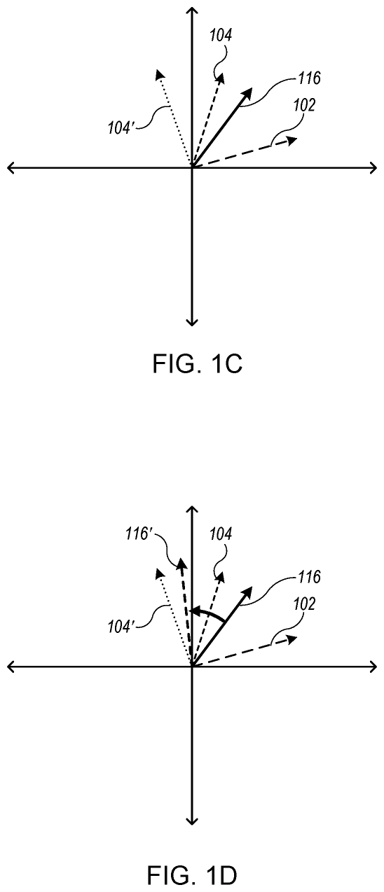

FIGS. 1A-1D illustrate the OSCaR approach using a simplified two-dimensional representation of word vectors. In step 1 (FIG. 1A), two concept subspaces are identified for which orthogonality is desirable. The subspaces can be identified by manually making appropriate lists of representative words of each type. These lists need not be exhaustive and may include, e.g., around a dozen to a hundred words. In this example, one subspace, represented by vector 102, is defined by considering pairs of words that are similar except as to gender, such as “man”/“woman,” “boy”/“girl”, “he”/“she, “uncle”/“aunt,” and so on. The other subspace, represented by vector 104, includes words identifying occupations, such as “doctor,” “engineer,” “nurse,” “maid,” and so on; these are words that denote occupations people can have regardless of gender. A subspace vector can be computed for each subspace by subtracting the vectors for paired words and determining a mean of the difference or by determining mean vectors for each concepts, then performing the subtractions. As shown in FIG. 1A, the subspace vectors 102 (gendered pairs) and 104 (occupations) are not orthogonal, indicating that gender words and occupation words are correlated.

As shown in FIG. 1B, the subspace vectors can be made orthogonal by applying a rotation to one of the subspace vectors. In this example, occupations vector 104 is rotated to vector 104′, which is orthogonal to gender vector 102.

Next, as shown in FIGS. 1C and 1D, a rectification can be applied to any word that has a vector representation in the language model. The OSCaR approach performs rectification using a graded rotation, with the amount of rotation for a given word determined based on its similarity to gender vector 102 and occupations vector 104. For instance, a maximum rotation angle can be equal to the rotation angle between vector 104 and vector 104′, and a minimum rotation angle can be zero. The rotation angle for a given word is selected based on relative similarity to gender vector 102 and occupations vector 104, with the angle being lower for words whose vectors are more similar to gender vector 102 and higher for words whose vectors are more similar to occupations vector 104. In FIG. 1C, vector 116 represents an arbitrary word such as “car,” “family,” or “football” that is neither an occupation nor a gender word. As shown in FIG. 1D, vector 116 is rotated to vector 116′. The graded rotation can help to avoid removing wanted associations. For instance, a word such as “actress” would be similar to gender vector 102 and would be rotated little or not at all, while a word such as “chauffeur” would be similar to occupation vector 104 and would be rotated accordingly. The rectification operation can be applied to every word in the language model, including the words used to determine gender vector 102 and occupations vector 104.

Certain embodiments of the present invention provide debiasing techniques that may be more effective than OSCaR at removing bias without also removing wanted associations. Some embodiments can use a graded rotation similar to OSCaR. However, the center of rotation is selected differently from OSCaR. In some embodiments, rectification can be performed iteratively to further improve the debiasing, and the number of iterations can be a fixed number or a number that is selected based on a convergence criterion, examples of which are described below. In some embodiments, the debiasing techniques can be extended to more than two subspaces.

According to some embodiments, a “concept” can be treated as a set of words with high mutual similarity and can be represented, e.g., as the mean point of those words. For example, one concept can include definitionally male words (e.g., “man,” “he,” “his,” “him,” “boy”). Another concept can include definitionally female words (e.g., “woman,” “she, “her,” “hers,” “girl”). (For simplicity of description, gender is treated herein as a binary, while acknowledging that gender is not in fact limited to a binary; “male” and “female” can also be understood as end regions in a spectrum of gender.) Given a pair of concepts, a direction (or “concept vector”) can be defined as the vector between the means of the two concepts. For two pairs of concepts, two concept vectors can be defined. Rectification can then be performed within a subspace spanned by the two concept vectors by defining a center point, translating a given word vector to the center point, then applying a graded rotation.

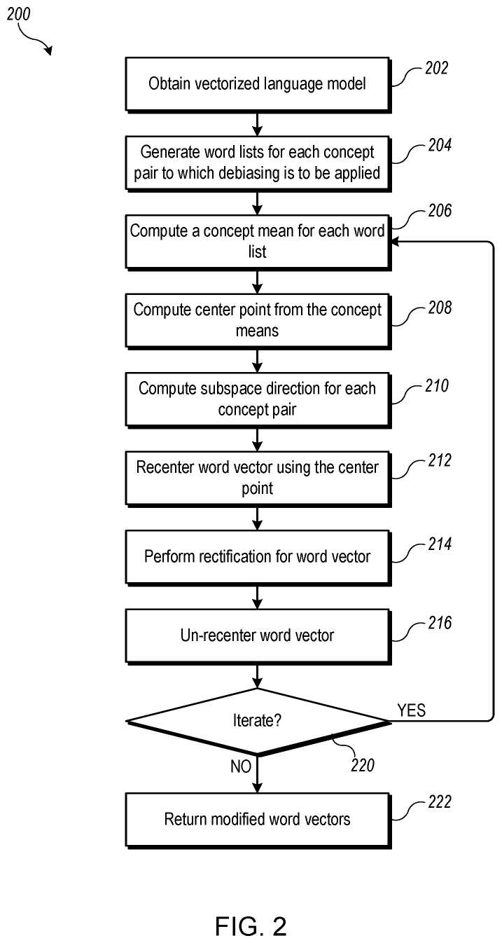

FIG. 2 shows a flow diagram of a process 200 for iterative subspace rectification according to some embodiments. Process 200, which can be implemented in a computer system, performs debiasing in relation to two concept pairs.

At block 202, a vectorized language model is obtained. A vectorized language model can be obtained by training a model using a corpus of documents, which can include any documents in the language being modeled. Existing models, including non-contextual models such as Word2Vec, GloVe, FastText, or the like can be used. Other algorithms and techniques for language modeling can also be used, and debiasing operations described herein can be applied across a range of vectorized language models. In some embodiments, block 202 can include obtaining a pre-trained language model from some other source.

At block 204, word lists can be created for each concept pair to which debiasing is to be applied. As used herein, a “concept” refers generally to a set of words that have high mutual similarity, and a “concept pair” refers to two concepts that are considered to be mutually exclusive with, in tension with, or in some sense opposed to, each other (such as male/female, pleasant/unpleasant, career/family, etc.). For instance, suppose it is desired to debias (or remove correlations between) gender and career/family terms. In this example, four concepts are implicated (male and female form one concept pair, career and family form another), and four word lists would be created. It should be understood that concept pairs can be defined as desired, and that any two concept pairs can be chosen for debiasing. In practice, these choices may be driven by human understanding and intuition about language and culture (e.g., that “female” words are likely to biased toward “family” words while “male” words are likely to be biased toward “career” words).

In some embodiments, word lists can be created manually for various concepts. e.g., by having a person or group of people generate a bespoke list of words representative of each concept. In other embodiments, each list can be seeded manually (e.g., by having a person or group of people list a dozen or so representative words) and further augmented using the vector representation. For instance, the list of seed words provided by a person can be augmented by computing a mean vector from the list of seed words and identifying up to some number of nearest neighbor words in the vector space. In various embodiments, a word list can include between about a dozen and a hundred words; a particular size is not critical. The same word can be included in multiple lists; for instance, “uncle” might be both a male-gender word and a family word. Some examples are provided below.

At block 206, a “concept mean” (y) can be computed for each word list, e.g., by computing the mean of the vectors of the words in each list. Each concept mean can be treated as representing one of the concepts. In mathematical terms, suppose that the debiasing is to be performed between two pairs of concepts, such as male/female gender and career/family. The word lists for first pair of concepts can be denoted as sets A and B, the word lists for the second pair as sets X and Y. The mean of set A can be defined as:

$$μ ( A ) = \frac{1}{\vert A \vert} {\sum }_{a ∈ A} a , \qquad ( 1 )$$

where |A| is the number of elements (words) in set A and a represents the vector coordinates of a specific word in set A. Means μ(B), μ(C), and μ(D) can be defined in a corresponding manner for the other concepts.

At block 208, a center point for subspace rotations can be computed; for instance, the center point can be the mean of the concept means computed at block 206. In mathematical terms, the center point can be computed using:

$${c}_{AB} = \frac{( μ ( A ) + μ ( B ) )}{2} ; \qquad ( 2 )$$

$${c}_{XY} = \frac{( μ ( X ) + μ ( y ) )}{2} ; \qquad ( 3 )$$

$$c = \frac{( {c}_{AB} + {c}_{XY} )}{2} = \frac{( μ ( A ) + μ ( B ) + μ ( X ) + μ ( Y ) )}{4} . \qquad ( 4 )$$

At block 210, a subspace direction (or subspace vector) can be computed for each concept pair. For instance, a subspace direction for a gender subspace can be computed by subtracting the concept mean of the “male” word list from the concept mean of the “female” word list (or vice versa). Similarly, a subspace direction for the career/family terms can be computed by subtracting the concept mean of the “career” word list from the concept mean of the “family” word list (or vice versa). More generally, the subspace vectors can be defined as:

$${v}_{1} = μ ( A ) - μ ( B ) ; \qquad ( 5 )$$

$${v}_{2} = μ ( X ) - μ ( Y ) . \qquad ( 6 )$$

After centering and projecting onto the span of v₁ and v₂, the midpoints C_{AB} and c_{XY} are close to the origin, particularly if the gap ∥c_{AB}-c_{XY}∥ is small and/or the connecting vector C_{AB}-c_{XY} is nearly orthogonal with v₁ and v₂.

After block 210, the center point c and subspace vectors v₁ and v₂ can be used to modify any or all of the word vectors in the language model. This can include the word vectors corresponding to words in the word lists for each concept, as well as word vectors corresponding to words that were not in any of the word lists.

More specifically, at block 212, a word vector in the vectorized language model can be recentered using the center point computed at block 208, e.g., by subtracting the center point from the vector (a translation operation). In mathematical terms, for a word vector w, a recentered vector we can be computed as:

$${w}_{c} = w - c , \qquad ( 7 )$$

where c is given by Eq. (4).

At block 214, the recentered word vector can be rectified, e.g., by rotation within a span defined by the subspace vectors. In some embodiments, rectification can use a graded rotation similar or identical to graded rotations used in OSCaR. For instance, a rotation matrix can be defined that rotates v₂ through an angle θ to a vector v₂′ that is orthogonal to v₁. The rotation angle for any other recentered word vector we can be determined based on the angle between that word vector and v₁. For example, similarly to OSCaR, a rotation angle θ, for a recentered word vector can be defined as:

$${θ}_{q} = \{ \begin{matrix}θ \frac{{ϕ}_{1}}{{θ}^{′}} if {d}_{2} > 0 and {ϕ}_{1} < {θ}^{′} \\ θ \frac{π - {ϕ}_{1}}{π - {θ}^{′}} if {d}_{2} > 0 and {ϕ}_{1} > {θ}^{′} \\ θ \frac{π - {ϕ}_{1}}{{θ}^{′}} if {d}_{2} < 0 and {ϕ}_{1} \geq π - {θ}^{′} \\ θ \frac{{ϕ}_{1}}{π - {θ}^{′}} if {d}_{2} < 0 and {ϕ}_{1} < π - {θ}^{′}\end{matrix} \qquad ( 8 )$$

$$where {ϕ}_{1} = arc cos 〈 {v}_{1} , \frac{q}{‖ q ‖} 〉 , {d}_{2} = 〈 {v}_{2}^{′} , \frac{q}{‖ q ‖} 〉 ,$$

and θ′=arccos [symbol] v₁, v₂ [symbol] . (The notation [symbol] , [symbol] indicates the vector dot product, and ∥·| indicates magnitude of a vector.)

Eq. (8) is mathematically similar to the graded rotation used for rectification in OSCaR. However, in process 200, the graded rotation is applied after re-centering at block 212, which can yield very different results from OSCaR. It should be understood that other graded rotations or other rectification techniques can be substituted.

At block 216, the rectified word vector can be un-recentered, e.g., by adding the center point computed at block 208 to the rectified word vector (inverting the translation applied at block 212).

By performing blocks 212-216 for each word vector, a modified vector can be generated for any or all words in the language model, including but not limited to the words in the word lists used to define the concept pairs.

One round of rectification may not result in fully orthogonalizing the concept vectors. That is, if the concept means μ(A), μ(B), μ(C), and μ(D) and vectors v₁ and v₂ are recomputed using the original word lists and the modified word vectors produced by process 200, it might not be the case that v₁ and v₂ are orthogonal. In some embodiments, process 200 can iterate to approach orthogonality of the concept vectors. Accordingly, at block 220, a determination can be made as to whether another iteration of rectification should be performed. Various stopping criteria can be used. For instance, a predetermined, fixed number of iterations (e.g., 1, 2, 4, 10, or some other number) can be selected. As another example, a convergence criterion can be defined. The convergence criterion can be based on re-computing the subspace directions after modifying the word vectors for the words in the word lists and determining how much the subspace directions (or the dot product between vectors v₁ and v₂) have shifted; iterations can continue until the shift drops below some threshold. (As shown in examples below, process 200 can converge within ten or fewer iterations.) If the rectification procedure should be iterated, process 200 returns to block 206, using modified word vectors as input. (The same word lists can be used at each iteration.) Once the last iteration is complete, process 200 can return the modified word vectors at block 222.

In process 200, the only augmentation to the word vectors is the rectification (e.g., graded rotation) applied at block 214. As noted, this can be applied to all word vectors in the language model as a continuous movement that is (sub-)differentiable and therefore generalizes to all other vectorized representations that may carry some of the connotations of a concept, including words that were not in the word lists generated at block 204. For instance, statistically gendered names (such as Amy or John) may carry or represent gender information in the embedding, but it may not be desirable to assign a gender to the name since persons with that name may not identify with the statistically most likely gender. It should also be noted that after rotation in the subspace, the full dimensionality of the vectors is restored. Thus, the rotation may affect 2 of a large number (e.g., 300 or perhaps larger) of dimensions in the proper basis, and the overall effect on most word representations may be small, with words most strongly correlated with the target concept vectors being most affected.

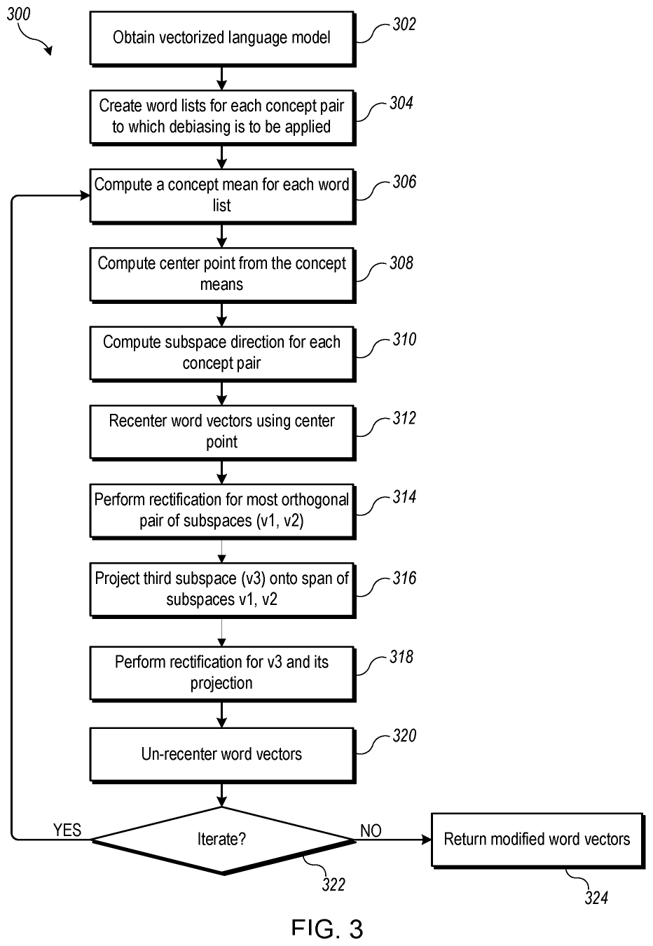

Process 200 provides iterative rectification of two subspaces. In some embodiments, more than two subspaces can be concurrently rectified. FIG. 3 shows a flow diagram of a process 300 for iterative rectification of three subspaces according to some embodiments. Process 300 can be similar to process 200, except that during each iteration, rectification is performed in stages for the various subspaces.

At block 302, a vectorized language model is obtained, similarly to block 202 of FIG. 2. At block 304, word lists can be created for each concept to which debiasing is to be applied, similarly to block 204 of FIG. 2. In this case it is assumed that there are three pairs of concepts to be considered (e.g., male/female, career/family, and pleasant/unpleasant). In mathematical terms, the pairs of concepts can be denoted as sets A and B, X and Y, and R and S.

At block 306, a “concept mean” (μ) can be computed for each word list, e.g., by computing the mean of the vectors of the words in each list. Each concept mean can be treated as representing one of the concepts. Block 306 can be similar to block 206 of FIG. 2 (e.g., using Eq. (1) to compute each concept mean), except that in this case there are six rather than four concept means.

At block 308, a center point for subspace rotations can be computed, similarly to block 208 of FIG. 2. In some embodiments, the center point c can be defined as:

$$c = \frac{( μ ( A ) + μ ( B ) + μ ( X ) + μ ( Y ) + μ ( R ) + μ ( S ) )}{6} . \qquad ( 9 )$$

At block 310, a subspace direction (or subspace vector) can be computed for each concept pair. Block 310 can be similar to block 210 of FIG. 2, except that in this case there are three rather than two subspace directions. In some embodiments, the directions can be defined as vectors.

$${v}_{1} = μ ( A ) - μ ( B ) ; \qquad ( 10 )$$

$${v}_{2} = μ ( X ) - μ ( Y ) ; \qquad ( 11 )$$

$${v}_{3} = μ ( R ) - μ ( S ) . \qquad ( 12 )$$

After block 310, the center point c and subspace vectors v₁, v₂, and v₃ can be used to modify any or all of the word vectors in the language model. This can include the word vectors corresponding to words in the word lists for each concept, as well as word vectors corresponding to words that were not in any of the word lists.

More specifically, at block 312, a word vector in the vectorized language model can be re-centered using the center point computed at block 308, e.g., by subtracting the center point from the vector, similarly to block 212.

At block 314, a first rectification operation can be performed on the word vectors with respect to a first pair of the subspaces (referred to for convenience as v₁ and v₂). In some embodiments, the first pair of subspaces can be the pair that are closest to orthogonal. Rectification can use a graded rotation similar or identical to graded rotations used at block 214 of process 200.

At block 316, the third subspace v₃ can be projected onto the span of subspaces v₁ and v₂; the projection is denoted herein as v1/3.

At block 318, a second rectification operation can be performed on the word vectors (as modified by the first rectification operation at block 314) with respect to the pair of subspaces v₃ and v1/3. As at block 314, the rectification operation can use a graded rotation similar or identical to graded rotations used at block 214 of process 200.

At block 320, the rectified word vectors resulting from block 318 can be un-recentered, e.g., by adding the center point computed at block 308 to the vector (inverting the translation applied at block 312).

By performing blocks 312-318 for each word vector, a modified vector can be generated for any or all words in the language model, including but not limited to the words in the word lists used to define the concept pairs.

As in process 200, one round of rectification may not result in fully orthogonalizing the concept vectors. Accordingly, at block 322, a determination is made as to whether another iteration of rectification should be performed. Various stopping criteria can be used, including any of the criteria described above with reference to block 220 of process 200. If the rectification procedure should be iterated, process 300 returns to block 306, using the modified word vectors as input. (The same word lists can be used at each iteration.) It should be noted that this results in each iteration performing both rectification steps, rather than iterating on just one pair of subspaces. Once the last iteration is complete, process 300 can return the modified word vectors at block 324.

Processes 200 and 300 are illustrative, and variations and modifications are possible. Operations described sequentially can be performed in parallel, and the order of operations may be modified as desired, except where logic dictates otherwise. Rectification can be applied to language models of any size including any number of words and vectors of any dimensionality desired. The number of iterations can be 1 or more, and the stopping criterion can be a predetermined number of iterations (e.g., 4 or 10 iterations) or can be determined dynamically, e.g., based on analysis of results after each iteration. Further, while process 200 illustrates rectification for two subspaces (two pairs of concepts) and process 300 illustrates rectification for three subspaces (three pairs of concepts), those skilled in the art with access to this disclosure will appreciate that the rectification process can be extended to larger numbers of subspaces by generalizing process 300 to successively project additional subspaces into a previous subspace and apply rectifications. The orthogonalization techniques described herein do not remove information about a word but instead represent it in a subspace orthogonal to other attributes.

To further illustrate iterative subspace rectification (ISR) processes according to various embodiments, example implementations will now be described. It should be understood that these examples are intended as illustrative and not limiting. In these examples, performance metrics are defined to estimate how well a given debiasing process rectifies (or orthogonalizes) concepts and how well it reduces bias. In particular, a dot product score is used herein to measure the level of orthogonality between two concept pairs (also sometimes referred to as “linearly-learned concepts”). The dot product can be the Euclidean dot product, denoted as [symbol] v₁, v₂ [symbol] . If the concept pairs are orthogonal, the dot product should be 0.

To measure bias, the Word Embedding Association Test (WEAT) can be used. The goal of WEAT is to measure the level of human-like stereotypical bias associated with words in word embeddings. WEAT uses four sets of words: two target word sets X and Y and two sets of attribute words A and B. For each word w ∈ (X ∪ Y), the association of w with sets A and B can be computed as:

$$s ( w , A , B ) = \frac{1}{\vert A \vert} {\sum }_{a ∈ A} cos ( a , w ) - \frac{1}{\vert B \vert} {\sum }_{b ∈ B} cos ( b , w ) . \qquad ( 13 )$$

Averaging Eq. (13) over all words in sets X and Y yields the WEAT score:

$$WEAT ( X , Y , A , B ) = \frac{1}{\vert X \vert} {\sum }_{x ∈ X} s ( x , A , B ) - \frac{1}{\vert Y \vert} {\sum }_{y ∈ Y} s ( y , A , B ) . \qquad ( 14 )$$

The score WEAT(X, Y, A, B) can be normalized by the standard deviation of s(w, A, B) over all words w ∈ (X U Y). The normalized WEAT score typically lies in the range [−1,1] and a value closer to 0 indicates less biased associations. The effect of debiasing can be measured by comparing WEAT scores before and after debiasing.

In a first example, associations between gender words and “pleasant/unpleasant” words (i.e., words with strong pleasant or unpleasant emotional resonance) were analyzed. Table 1 lists the gender words that were used, and Table 2 lists the pleasant/unpleasant words.

TABLE 1

| Male Terms | Female Terms |
|---|---|
| male, man, boy, brother, he, | female, woman, girl, sister, she, |
| him, his, son | her, hers, daughter |

TABLE 2

| Pleasant Terms | Unpleasant Terms |
|---|---|
| caress, freedom, health, love, peace, cheer, | abuse, crash, filth, murder, sickness, |
| friend, heaven, loyal, pleasure, diamond, | accident, death, grief, poison, stink, |
| gentle, honest, lucky, rainbow, diploma, | assault, disaster, hatred, pollute, |
| gift, honor, miracle, sunrise, family, | tragedy, bomb, divorce, jail, poverty, |
| happy, laughter, paradise, vacation | ugly, cancer, evil, kill, rotten, vomit |

Debiasing was performed on an initial language model using two different implementations of process 200 described above. In the following description, “SR” denotes an implementation with a single iteration of process 200, and “ISR” denotes an iterative implementation with 10 iterations. For comparison, debiasing was also performed on the same initial language model using each of five different conventional techniques, specifically: linear projection (LP); hard debiasing (HD); iterative null space projection (INLP); OSCaR; and an iterative version of OSCaR referred to herein as iOSCaR.

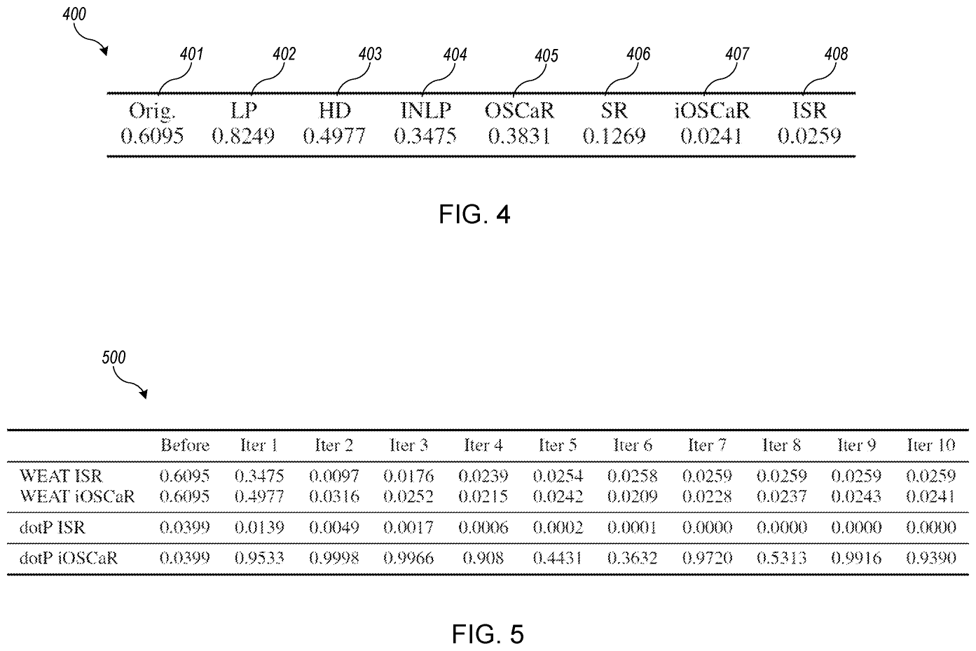

FIG. 4 is a table 400 summarizing the WEAT scores for various debiasing processes. For reference, the original WEAT score of the initial language model, prior to any debiasing, is shown at column 401. Results of conventional debiasing processes are shown in columns 402 (LP), 403 (HD), 404 (INLP), 405 (OSCaR), and 407 (iOSCaR). Results obtained using implementations of process 200 are shown at columns 406 (SR) and 408 (ISR).

Convergence of ISR was also studied by generating a WEAT score and a dot product score (dotP) after each iteration. FIG. 5 is a table 500 summarizing the scores at each iteration for ISR. Each column corresponds to a different iteration. For comparison, corresponding scores for iOSCaR are shown. It should be noted that ISR converges to a dot product score that approaches zero, indicating successful debiasing. By comparison, iOSCaR does not converge to any particular dot product score. It should also be noted that the WEAT score for ISR converges quicky to a stable value, and just 2-4 iterations may be sufficient.

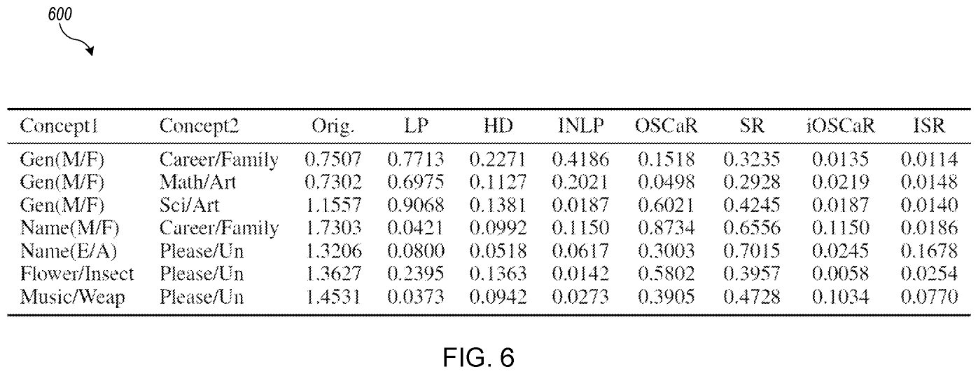

As a further example, the same processes were applied to other concept pairs. FIG. 6 is a table 600 summarizing the WEAT scores for different processes applied to different concept pairs. “Gen(M/F)” denotes gender words listed in Table 1 above. “Please/Un” denotes the pleasant/unpleasant words listed in Table 2 above. “Career/Family” words are listed in Table 3. “Math/Art” words are listed in Table 4, “Sci/Art” words are listed in Table 5. “Name(MrF)” words are listed in Table 6. “Flower/Insect” words are listed in Table 7. “Music/Weap” words are listed in Table 8. As FIG. 6 shows, for most data set pairs, ISR achieves the smallest WEAT score of all tested methods.

TABLE 3

| Career Terms | Family Terms |
|---|---|
| executive, management, professional, | home, parents, children, family, |
| corporation, salary, office, business, | cousins, marriage, wedding, |
| career | relatives |

TABLE 4

| Math Terms | Art Terms |
|---|---|
| math, algebra, geometry, calculus, | poetry, art, dance, literature, |
| equations, computation, numbers, | novel, symphony, drama, sculpture |
| addition | |

TABLE 5

| Science Terms | Art Terms |
|---|---|
| science, technology, physics, chemistry, | poetry, art, dance, literature, |
| einstein, nasa, experiment, astronomy | novel, symphony, drama, |
| | sculpture |

TABLE 6

| Name (M) Terms | Name (F) Terms |
|---|---|
| John, Paul, Mike, Kevin, Steve, | Amy, Joan, Lisa, Sarah, Diana, |
| Greg, Jeff, Bill | Kate, Ann, Donna |

TABLE 7

| Flower Terms | Insect Terms |
|---|---|
| aster, clover, hyacinth, marigold, poppy, | ant, caterpillar, flea, locust, spider, bedbug, |
| azalea, crocus, iris, orchid, rose, daffodil, | centipede, fly, maggot, tarantula, bee, |
| lilac, pansy, tulip, buttercup, daisy, lily, | cockroach, gnat, mosquito, termite, beetle, |
| peony, violet, carnation, magnolia, petunia, | cricket, hornet, moth, wasp, dragonfly, |
| zinnia | roach, weevil |

TABLE 8

| Musical Instrument Terms | Weapon Terms |
|---|---|
| bagpipe, cello, guitar, lute, trombone, | arrow, club, gun, missile, spear, axe, dagger, |
| banjo, clarinet, harmonica, mandolin, | harpoon, pistol, sword, blade, dynamite, |
| trumpet, bassoon, drum, harp, oboe, | hatchet, rifle, tank, bomb, firearm, knife, |
| tuba, bell, fiddle, harpsichord, | shotgun, teargas, cannon, grenade, mace, |
| piano, viola, bongo, flute, horn, | slingshot, whip |
| saxophone, violin | |

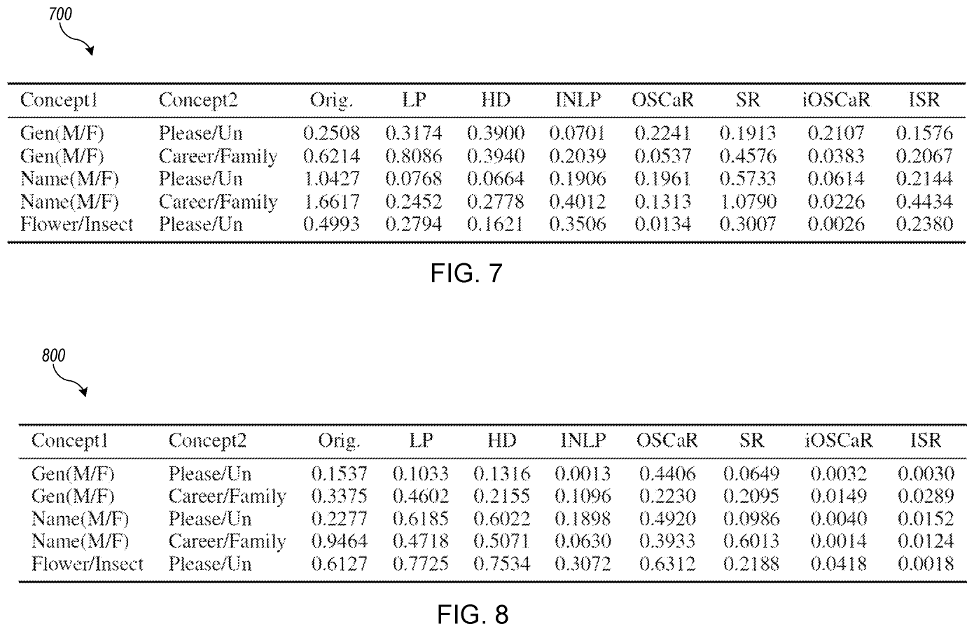

As yet another example, a study of the effect of cross-validation was performed. cross-validation, different lists of words are used for training (e.g., determining center points and the rotation angle for mapping v₂ to v₂′ in ISR) and testing (e.g., computing WEAT scores). To support cross-validation, larger word lists were constructed by using the small word lists (in Tables 1-8) and determining the mean, then selecting the 60 closest words to each mean. Each list was randomly split 50/50 into testing and training subsets. Debiasing was performed on the training subset, and WEAT scores were evaluated on the testing subset. This process was repeated 10 times (with 10 different random splits), and WEAT scores were averaged across the random splits. FIG. 7 shows a table 700 of WEAT scores obtained for the various debiasing processes with a test/train split, and FIG. 8 shows a table 800 of WEAT scores obtained using the same 60-word lists without a test/train split. FIGS. 7 and 8 show that ISR consistently performs among the best, with gendered names providing the weakest result. It is also noted that projection-based methods such as LP, HID, and INLP perform better with a test/train split, while rotation-based methods such as SR and ISR perform better with no split. This may be because rotation-based methods are more surgical and therefore more affected by smaller word lists.

Another consideration in evaluating debiasing algorithms is the extent to which they destroy important information in the vectorized representations. For example, certain task-specific challenges, such as pronoun resolution involving gender, may be adversely affected if the gender subspace is removed (e.g., by a projection-based debiasing method).

Task-based information preservation can be quantified using a score referred to herein as “Self-WEAT,” or “SWEAT.” Given a pair of word lists A, B defining a concept pair (e.g., male and female gendered terms), the SWEAT score measures how the coherence within each word list compares to cross-coherence with the other word list. To determine a SWEAT score, each word list can be randomly split: list A can be split into lists A₁ and A₂, and list B can be split into lists B₁ and B₂. A WEAT score WEAT(A₁, A₂, B₁, B₂) can be computed using Eqs. (13) and (14) above. The SWEAT score can be defined as the average of this WEAT score across ten different random splits. If lists A and B retain their distinct meanings after debiasing, then the SWEAT scores before and after debiasing should be similar. If the distinction is reduced or destroyed, then the SWEAT score will decrease toward 0 after debiasing.

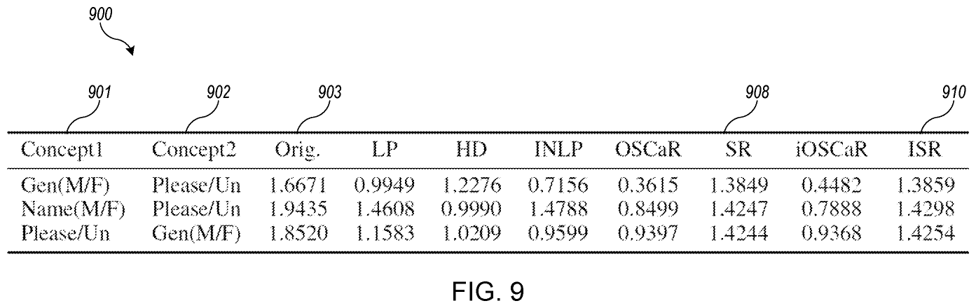

FIG. 9 shows a table 900 of SWEAT scores for various concept pairs and various debiasing methods. “Concept1” (column 901) is the concept to which linear debiasing is applied, and “Concept2” (column 902) is the second concept for rotation-based debiasing. Column 903 shows the SWEAT score before debiasing. It is noted that SR (column 908) and ISR (column 910) have little effect on the SWEAT score, indicating that ISR preserves most or all pertinent information. Conventional debiasing methods, by contrast, significantly decrease the SWEAT scores.

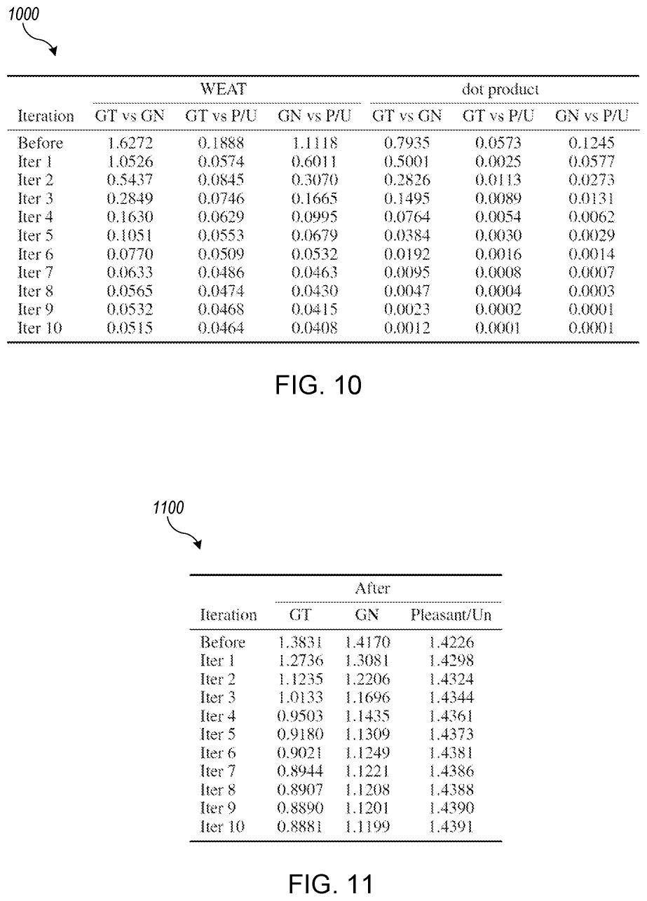

As still another example, an implementation of process 300 was applied to debias three concept pairs: gendered male/female terms; pleasant/unpleasant terms; and statistically gendered male/female names. Large word lists, generated as described above, were used. It was observed that gendered terms and pleasant/unpleasant terms had the smallest dot product; accordingly, the first rectification was performed using these two concept pairs, followed by rectification with statistically gendered names. FIG. 10 shows a table 1000 of WEAT scores and dot product scores for the three-pair ISR process across ten iterations, for each pair of concepts. In table 1000, “GT” denotes gendered terms, “GN” denotes gendered names, and “P/U” denotes pleasant/unpleasant terms. Table 1000 shows all pairwise WEAT scores decreasing significantly (to about 0.04) after 10 iterations, while the pairwise dot products also decrease toward zero.

FIG. 11 shows a table 1100 of SWEAT scores for each concept pair at each iteration of the three-pair ISR process. It is noted that pleasant/unpleasant terms retain most of their SWEAT score even after 10 iterations, while SWEAT scores for both gendered terms and gendered names decrease. This is likely due to the fact that gendered terms and gendered names start with high correlation (dot product score of 0.79), and significant warping occurs to orthogonalize the concept vectors. Even so, the SWEAT scores shown in FIG. 11 are higher than corresponding SWEAT scores for other methods (as shown in FIG. 9).

As shown in the foregoing examples, debiasing according to some embodiments can significantly improve the amount of debiasing compared to conventional methods. For instance, instead of about 20-30% improvement, debiasing according to some embodiments can attain 95% improvement when measured using the standard WEAT score. This significant improvement is maintained under a test-train split experiment (which is rarely attempted in this domain). Moreover, while some conventional debiasing techniques (e.g., Hard Debiasing, INLP) are based on projections, and hence destroy information of the concept for which bias is attenuated (e.g., gender), debiasing according to some embodiments can be shown to preserve the relevant information. Furthermore, debiasing according to some embodiments can be extended to multiple subspace debiasing (e.g., as described above with reference to FIG. 3), which may help to address intersectional issues. The resulting representation creates multiple subspaces, all orthogonal. The resulting representation is also more interpretable than other debiasing representations. After applying this orthogonalization to multiple subspaces, it is possible to perform a basis rotation (that does not change any cosine similarities or Euclidean distances) that results in each of the identified and orthogonalized concepts being aligned to one of the coordinate axes. Thus, the power, flexibility, and compression of a distributed representation can be maintained while still being able to recover, at least for select concepts, the intuitive and simple coordinate representation of those features. In downstream tasks, the features related to debiased concepts can be ignored in instances where they should not be involved in some aspect of training (e.g., gender for resume sorting), or they can be retained for co-reference resolution.

While the foregoing description makes reference to specific embodiments, those skilled in the art will appreciate that the description is not exhaustive of all embodiments. Many variations and modifications are possible. For instance, while male/female, career/family, and other specific concept pairs are used as examples, debiasing can be performed for any two or more pairs of concepts in a similar manner. As another example, a financial services institution may maintain data (which can be anonymized data) relating to financial transactions of various users, and it may be desirable to create a vectorized language model from the data to support operations such as fraud detection or making recommendations of merchants to patronize or items to purchase based on past patterns of behavior. There may be unwanted associations between location and particular merchants or items that it may be desirable to remove. More generally, concepts can be defined by clusters in the language model, and subspaces can be defined by selecting pairs of concepts.

Further, embodiments described above use concept pairs, in which two word lists are defined to represent distinct concepts. An alternative approach uses subspaces defined by a single word list (e.g., occupations). In this approach, the single-set subspace can be defined as the top principal component of the vectors in the word list. Thus, given two word lists, lines [symbol] and [symbol] in [symbol] (the high-dimensional vector space of the language model). To identify a center, the pair of points p₁ ∈ [symbol] and p₂ ∈ [symbol] that are as close as possible can be determined analytically. The center c can be chosen as the midpoint between p₁ and p₂, e.g., c=(p₁+p₂)/2. Rectification can proceed as described above with reference to process 200 (or process 300). Iteratively applying this method results in a dot product that converges toward zero; however, evaluating information retention becomes challenging in the absence of contrasting concepts.

The vectorized language representation can include representations of any number of words and can correspond to any natural language. The word vectors in the representation can include any number of vector components. Techniques described herein can be used to remove unwanted associations between two or more pairs of concepts (referred to herein as “bias”). Whether an association is wanted or unwanted may depend on the particular purpose for which the vectorized language representation is being used. As described above, debiasing can be performed without requiring computationally intensive training or retraining of the model, and debiasing according to some embodiments can provide a lightweight augmentation to a vectorized language model.

Word lists can be generated using a variety of techniques. Examples include bespoke word lists generated by a person or group of people. Existing word lists available from various sources can be used. In some embodiments, a short word list (e.g., a dozen or so words) generated by a person can be augmented using automated processes. For instance, a mean vector of words in an initial (short) word list can be computed (e.g., using Eq. (1) above), and words for the final word list can be selected based on similarity to the mean vector, e.g., the closest 40, 60 or 100 words, or words within some threshold distance from the mean vector. Where such techniques are used, the words in the initial list might or might not be included in the final word list.

Techniques described herein can be implemented by suitable programming of general-purpose computers. In some embodiments, a computer system includes a single computer apparatus, where the subsystems can be components of the computer apparatus. The computer apparatus can have a variety of form factors including, e.g., a smart phone, a tablet computer, a laptop computer, a desktop computer, etc. In other embodiments, a computer system can include multiple computer apparatuses, each being a subsystem, with internal components. Debiasing techniques of the kind described herein can improve the performance of various tasks in which natural language models are used, e.g., by reducing the effect of stereotypical associations in the training corpus that may lead to unwanted stereotypical behavior in a natural-language processing system.

A computer system can include a plurality of components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Rust, Golang, Swift, or scripting language such as Perl or Python using, for example, conventional or object-oriented techniques. The software code may be stored as a series of instructions or commands on a computer readable storage medium; suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable storage medium may be any combination of such storage devices or other storage devices capable of retaining stored data.

Such programs may also be encoded and transmitted using carrier signals adapted for transmission via wired, optical, and/or wireless networks conforming to a variety of protocols, including the Internet. As such, a computer readable transmission medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

The above description is illustrative and is not restrictive. Many variations of the invention will become apparent to those skilled in the art upon review of the disclosure. The scope of patent protection should, therefore, be determined not with reference to the above description, but instead should be determined with reference to the following claims along with their full scope or equivalents.

What is claimed is:

1. A computer-implemented method comprising:
obtaining a vectorized language representation for a plurality of words, wherein the vectorized language representation includes a plurality of vectors in a vector space such that each word has an associated vector;
identifying two pairs of concepts to be debiased;
obtaining a representative word list for each concept in each pair of concepts;
computing, for each concept, a respective concept mean from the vectors associated with the words in the representative word list for that concept;
computing a center point of the respective concept means;
computing a respective subspace direction for each pair of concept means; and
for one or more of the plurality of vectors in the vector space, computing a debiased vector, wherein computing the debiased vector includes:
recentering the vector on the center point;
performing a rectification operation on the vector with respect to the respective subspace directions; and
un-recentering the vector.

2. The method of claim 1 further comprising:
iteratively computing the respective concept means; computing the center point; computing the respective subspace directions; recentering the vector; performing the rectification operation; and un-recentering the vector until a stopping criterion is met.

3. The method of claim 2 wherein the stopping criterion is a convergence criterion based on a change in a performance metric.

4. The method of claim 2 wherein the stopping criterion specifies a fixed number of iterations.

5. The method of claim 1 wherein performing the rectification operation on the vector includes:
determining a rotation angle to apply to the vector; and
rotating the vector by the rotation angle.

6. The method of claim 5 wherein the rotation angle is based on a relative similarity of the vector to the respective subspace directions for each pair of concept means.

7. The method of claim 1 wherein the vectorized language representation is obtained from structured text.

8. The method of claim 1 further comprising:
storing the one or more debiased vectors.

9. A computer system comprising:
a memory to store a vectorized language representation that includes a plurality of vectors in a vector space such that each word has an associated vector; and
a processor coupled to the memory and configured to:
identify two pairs of concepts to be debiased;
obtain a representative word list for each concept in each pair of concepts;
compute, for each concept, a respective concept mean from the vectors associated with the words in the representative word list for that concept;
compute a center point of the respective concept means;
compute a respective subspace direction for each pair of concept means; and
for one or more of the plurality of vectors in the vector space:
recenter the vector on the center point;
perform a rectification operation on the vector with respect to the respective subspace directions; and
un-recenter the vector.

10. The computer system of claim 9 wherein the processor is further configured to iteratively compute the respective concept means, compute the center point, compute the respective subspace directions, recenter the vector, perform the rectification operation, and un-recenter the vector until a stopping criterion is met.

11. The computer system of claim 9 wherein the representative word lists are generated by a human.

12. The computer system of claim 9 wherein the processor is further configured such that obtaining a representative word list for each concept in each pair of concepts includes, for at least one of the concepts:
receiving an initial word list generated by a human;
determining a mean of word vectors corresponding to words in the initial word list; and
selecting words for the representative word list based on vector similarity to the mean of word vectors.

13. The computer system of claim 9 wherein the processor is further configured such that performing the rectification operation on the vector includes:
determining a rotation angle to apply to the vector; and
rotating the vector by the rotation angle.

14. The computer system of claim 13 wherein the rotation angle is determined based at least in part on an angle between the vector and one of the subspace directions.

15. A computer-readable storage medium having stored therein program code instructions that, when executed by a processor in a computer system, cause the computer system to perform a method comprising:
obtaining a vectorized language representation including a plurality of words, wherein the vectorized language representation includes a plurality of vectors in a vector space such that each word has an associated vector;
identifying a plurality of pairs of target concepts to be debiased;
generating a representative word list for each concept in each pair of target concepts;
computing, for each concept, a respective concept mean from the vectors associated with the words in the representative word list for that concept;
computing a center point of the respective concept means;
computing a respective subspace direction for each pair of concept means;
centering each vector in the vectorized language representation on the center point;
performing a first rectification of each vector with respect to a first two of the subspace directions;
projecting a third one of the subspace directions onto the span of the first two subspace directions;
performing a second rectification of each vector with respect to the third subspace direction and the projection; and
uncentering each vector.

16. The computer-readable storage medium of claim 15 further comprising:
iteratively computing the respective concept means; computing the center point; computing the respective subspace directions; centering each vector; performing the first rectification of each vector; projecting the third one of the subspace directions; performing the second rectification of each vector; and uncentering each vector until a stopping criterion is met.

17. The computer-readable storage medium of claim 16 wherein the stopping criterion is a convergence criterion based on a change in a performance metric.

18. The computer-readable storage medium of claim 16 wherein the stopping criterion specifies a fixed number of iterations.

19. The computer-readable storage medium of claim 15 wherein performing each of the first and second rectifications on each vector includes:
determining, based at least in part on a relative similarity of the vector to the respective subspace directions for the pair of concept means, a rotation angle to apply to the vector; and
rotating the vector by the rotation angle.

20. The computer-readable storage medium of claim 15 wherein the first two of the subspace directions are the most nearly orthogonal pair of the subspace directions.
